(19) United States
(12) Patent Application Publication
(10) Pub. No.: US 2006/0159874 A1
(43) Pub. Date: Jul. 20, 2006

(54) Windows having multiple polymer layers

(75) Inventors: Francois Andre Koran, Longmeadow, MA (US); Aristotelis Karagiannis, Amherst, MA (US); William Paul Bell, Reston, VA (US)

Correspondence Address: BRENC LAW, 47 BANKS ROAD, SIMSBURY, CT, 06070, US

(73) Assignee: Solutia, Inc.

(21) Appl. No.: 11/036,583

(22) Filed: Jan. 18, 2005

(51) Int. Cl. E06B 3/24; B32B 17/10

(52) U.S. Cl. 428/34; 428/339; 428/426; 428/430

(57) ABSTRACT

The present invention is in the field of windows having multiple layer polymers disposed thereon, and more specifically, the present invention is in the field of multiple pane windows having multiple layer polymers disposed on one or more panes.

### FIELD OF THE INVENTION

The present invention is in the field of windows having multiple polymer layers disposed thereon, and more specifically, the present invention is in the field of multiple pane windows having multiple polymer layers disposed on one or more panes.

### BACKGROUND

Poly(vinyl butyral) (PVB) is commonly used in the manufacture of polymer sheets that can be used as interlayers in light-transmitting laminates such as safety glass or polymeric laminates. Safety glass typically refers to a transparent laminate comprising a poly(vinyl butyral) sheet disposed between two panes of glass. Safety glass often is used to provide a transparent barrier in architectural and automotive openings. Its main function is to absorb energy, such as that caused by a blow from an object, without allowing penetration through the opening.

Insulated glass units (IGUs), which are commonly used in architectural windows, can comprise two panes of glass separated by an enclosed space. The enclosed space, which can be sealed and filled with an insulating gas, serves to improve the heat transfer properties of the window, which can lead to improved thermal performance of the window. Performance films, such as those produced with poly(ethylene terephthalate), can further be added to one or both panes of glass in an insulated glass unit to improve the optical and thermal properties of the window.

Insulated glass units can be made with conventional safety glass laminates in place of one or more single panes. These configurations, however, add weight to the unit because they require at least one additional pane of glass. Further, the design of the window frame will generally have to be altered to accommodate the significant increase in the thickness of one or more of the panes. Also, the insulation value of the unit may be negatively impacted by the inclusion of additional panes of glass.

As an alternative to conventional safety glass, insulated glass units can also be fitted with window films. These window films, which can comprise poly(ethylene terephthalate), for example, can be applied to the glass surface of the unit that is exposed to the living space side of the window, where they can function to improve the impact resistance, light transmission, and/or thermal properties of the unit and offer greater impact resistance while not necessarily diminishing thermal properties. Such films, however, do not necessarily provide the desired impact resistance, and are prone to physical damage such as scratching and deterioration due to exposure to cleaning chemicals. Hardcoats, which are sometimes applied over films, add an extra measure of scratch resistance, but over time even these fail to prevent scratching and surface defects.

Accordingly, further improved compositions and methods of manufacture for improved window units that are capable of offering greater impact resistance and thermal properties without significantly adding to the weight or reducing the insulation value are needed.

### SUMMARY OF THE INVENTION

Now, according to the present invention, multiple pane windows incorporating multiple polymeric layers on one or more interior surfaces of glass are provided. Further provided are methods of manufacturing such windows.

The present invention includes a multiple pane window, comprising: a first pane of glass having an inside surface; a second pane of glass having an inside surface, wherein said second pane of glass is disposed relative to said first pane of glass so as to form a space between said first pane of glass and said second pane of glass; a polymer sheet layer disposed in contact with said inside surface of said first pane of glass, wherein said polymer sheet layer has a thickness of 0.2 to 3.0 millimeters and comprises at least one polymer sheet; and, a polymer film disposed in contact with said polymer sheet layer.

The present invention includes a multiple pane window, comprising: a first pane of glass having an inside surface; a second pane of glass having an inside surface, wherein said second pane of glass is disposed relative to said first pane of glass so as to form a space between said first pane of glass and said second pane of glass; a polymer sheet layer disposed in contact with said inside surface of said first pane of glass, wherein said polymer sheet layer comprises at least one polymer sheet; and, a polymer film disposed in contact with said polymer sheet, wherein the impact strength of said first pane of glass with said polymer sheet layer and said polymer film is at least three meters.

### BRIEF DESCRIPTION OF THE FIGURES

FIG. 1 is a schematic cross-sectional illustration of two panes of glass.

FIG. 2 is a schematic cross-sectional illustration of a single pane of glass having a multiple polymer layer disposed thereon.

FIG. 3 is a schematic cross-sectional illustration of glass panes and multiple polymer layers during processing and before use in a window.

### DETAILED DESCRIPTION

The present invention is directed to multiple pane windows having multiple layers of polymers affixed thereto on an interior surface of one or more of the panes of glass in the multiple pane window. Such configurations can provide both increased impact resistance and improved thermal properties.

As used herein, a “multiple pane window” refers to any window for use in architectural applications that has two or more panes of glass disposed within a frame or are that are otherwise fixed in relative position, where at least two of the panes of glass are separated by a space, which can be filled with any appropriate gas, including, for example, air. In various embodiments the multiple pane window comprises or is an insulated glass unit that has two panes of glass organized in a parallel planar fashion and separated by a space.

These windows can be used in residential and commercial applications in place of standard single pane windows. In addition to two pane insulated glass units, multiple pane windows of the present invention also include windows that have more than two panes of glass. For example, a configuration in which three panes of glass arranged in a separated, parallel planar arrangement could comprise multiple polymeric layers according to the present invention. For embodiments of the present invention in which a two pane insulated glass unit is used, any conventional unit can be used that can accommodate the polymer layers of the present invention on at least one interior surface.

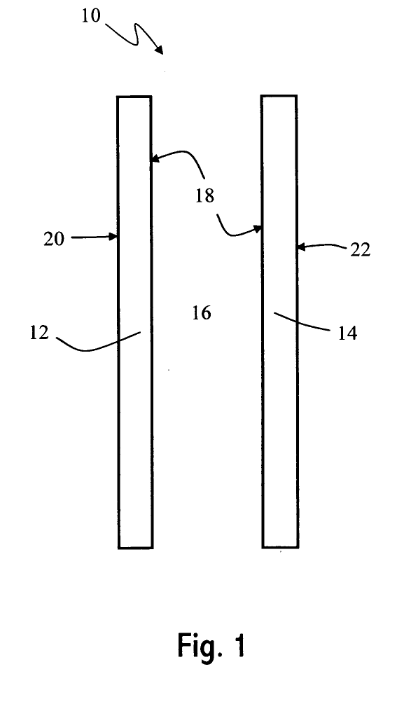

As shown in the schematic cross-section in FIG. 1 generally at 10, for a conventional two pane integrated glass unit, a first pane of glass 12 is disposed in an approximately parallel planar orientation to a second pane of glass 14 so as to create a space 16 between the two panes. The two panes of glass 12, 14 will generally be disposed in a window frame (not shown) so that they are held at a fixed distance from each other. In other embodiments, two or more panes of glass can be held at a fixed distance from each other with spacers, and optionally sealed, to form a multiple pane window that can be inserted into an appropriately sized opening. The two panes of glass 12, 14 can be sealed to the frame to prevent ingress and egress of gases or contaminants between the space 16 and environment on either side of the window. The space 16 can contain any air or gas that is conventionally used in the art. The panes of glass 12, 14 can be any that are used in the art in multiple pane windows, including loE type panes, solar control panes, and other panes specifically designed to improve thermal performance of the window.

Referring again to FIG. 1, the first pane of glass 12 and the second pane of glass 14 each have an interior surface 18. As used herein, an “interior surface” of a pane of glass in a multiple pane window is a surface that is exposed to the space 16 region of the window and not to the outside. In a two pane window, each pane will have one interior surface. In a three pane window, the middle pane can have two surfaces that would be “interior surfaces.”

The present invention provides improved multiple pane windows by adding to the interior surface of at least one pane of glass a multiple polymer layer structure that offers, among other improvements, improved impact resistance. Further, because the design of the present invention places the polymeric layers on the inside of a multiple pane window, the polymeric layers are not subject to the physical damage, such as scratching, that can occur when the polymer layers are exposed to the outside environment in which the window is disposed.

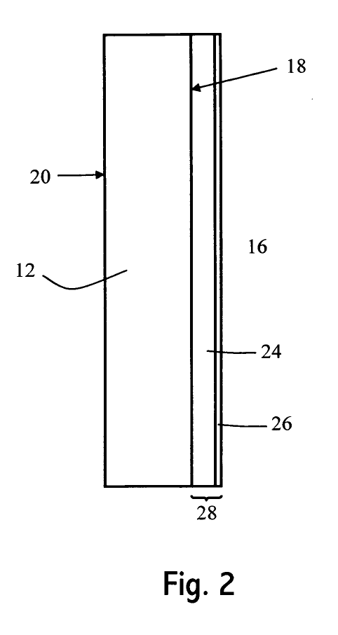

As shown in schematic cross-section in FIG. 2, the first pane of glass 12, for example, can have a polymer sheet 24 disposed on the interior surface 18, and a polymer film 26 disposed on the polymer sheet 24. Together, the polymer sheet 24 and the polymer film 26 form a multiple polymer layer 28 As will be discussed in detail below, the polymer sheet 24 can be any suitable polymer that has suitable optical, adhesive, and impact absorbing qualities. As will also be discussed in detail below, the polymer film 26 can be any polymer that has suitable optical and physical properties.

In addition to the embodiment shown in FIG. 2, further layers can be incorporated into the multiple polymer layer 28 according to the present invention. For example, additional layers of polymer sheet can be added between the glass and polymer film. Other embodiments include constructs having the following layering: glass/polymer sheet/polymer film/polymer sheet/polymer film. Further embodiments include disposing two or more layers of a thermoplastic polymer sheet between the glass or rigid substrate and the polymer film. In these embodiments, for example in a two polymer sheet embodiment, the polymer sheets can have different compositions, which can lead to desirable properties, for example, noise suppression.

In further embodiments, the rigid substrate can be any conventional plastic or glass, and in particular embodiments, the glass can be tempered glass or heat treated glass, the use of which would add greater strength to a window.

In other embodiments, solar control glass, or solar glass is used for one or more laminated glass panels of the present invention. Solar glass can be any conventional glass that incorporates one or more additives to improve the optical qualities of the glass, and specifically, solar glass will typically be formulated to reduce or eliminate the transmission of undesirable wavelengths of radiation, such as near infrared and ultraviolet. Solar glass can also be tinted, which results in, for some applications, a desirable reduction of transmission of visible light. Examples of solar glass that are useful in the present invention are bronze glass, gray glass, loE glass, and solar glass panels as are known in the art, including those disclosed in U.S. Pat. Nos. 6,737,159 and 6,620,872.

The present invention includes any multiple pane windows having any of the multiple polymer layers described herein disposed on at least one interior surface. In various embodiments, the present invention comprises multiple pane windows having two interior surfaces, each having disposed thereon a multiple polymer layer construct of the present invention. In these embodiments, the multiple polymer layers can be the same or different on each pane of glass. Further embodiments include three or more multiple polymer layers on three or more interior surfaces.

For any of the embodiments of the present invention, it is desirable for a multiple layer glass panel, such as a glass/polymer sheet/polymer film construct, to have sufficient “impact strength,” as defined elsewhere herein, to provide a desirable level of safety. In various embodiments of the present invention, a pane of glass having laminated thereon any of the multiple polymer layer constructs described herein can have an impact strength of at least 3 meters, at least 4 meters, at least 5 meters, at least 6 meters, at least 7 meters, at least 8 meters, at least 9 meters, or at least 10 meters. In embodiments in which more than one pane of glass has such a construct laminated thereon, further panes can have the same impact strengths, in any combination. For example, in an embodiment in which two layers of glass in an insulated glass unit each have a multiple polymer layer on their interior surface, each glass//multiple polymer layer can have an impact strength of at least 5 meters.

Polymer Film

As used herein, a “polymer film” means a relatively thin and rigid polymer layer that functions as a performance enhancing layer. Polymer films differ from polymer sheets, as used herein, in that polymer films do not themselves provide the necessary penetration resistance and glass retention properties to a multiple layer glazing structure, but rather provide performance improvements, such as infrared absorption character. Poly(ethylene terephthalate) is most commonly used as a polymer film.

The polymer film 26 shown in FIG. 2 can be any suitable film that is sufficiently rigid to provide a relatively flat, stable surface, for example those polymer films conventionally used as a performance enhancing layer in multiple layer glass panels. The polymer film is preferably optically transparent (i.e. objects adjacent one side of the layer can be comfortably seen by the eye of a particular observer looking through the layer from the other side), and usually has a greater, in some embodiments significantly greater, tensile modulus regardless of composition than that of the adjacent polymer sheet.

In various embodiments, the polymer film comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers and the like. In various embodiments, the polymer film comprises materials such as re-stretched thermoplastic films having the noted properties, which include polyesters. In various embodiments, the polymer film comprises or consists of poly(ethylene terephthalate), and, in various embodiments, the polyethylene terephthalate has been biaxially stretched to improve strength, and/or has been heat stabilized to provide low shrinkage characteristics when subjected to elevated temperatures (e.g. less than 2% shrinkage in both directions after 30 min. at 150 degrees C.).

In various embodiments, the polymer film can have a thickness of 0.013 mm to 0.20 mm, 0.025 mm to 0.1 mm, or 0.04 to 0.06 mm. The polymer film can optionally be surface treated or coated with a functional performance layer to improve one or more properties, such as adhesion or infrared radiation reflection. These functional performance layers include, for example, a multi-layer stack for reflecting infra-red solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example two) sequentially deposited, optically cooperating dielectric layers. As is also known, (see, for example, U.S. Pat. Nos. 4,017,661 and 4,786,783), the metal layer(s) may optionally be electrically resistance heated for defrosting or defogging of any associated glass layers. Various coating and surface treatment techniques for poly(ethylene terephthalate) film and other polymer films that can be used with the present invention are disclosed in published European Application No. 0157030. Polymer films of the present invention can also include a hardcoat and/or and antifog layer, as are known in the art.

Polymer Sheet

As used herein, a “polymer sheet” means any thermoplastic polymer composition formed by any suitable method into a thin layer that is suitable alone, or in stacks of more than one layer, for use as an interlayer that provides adequate penetration resistance and glass retention properties to laminated glazing panels. Plasticized poly(vinyl butyral) is most commonly used to form polymer sheets.

Specifically excluded from the definition of “polymer sheet” are layers of poly(vinyl butyral) and similar type materials that are applied in very thin layers for the purposes of adhesion only. These very thin layers that are applied for the purpose of adhering two non-adhering layers together (for example poly(ethylene terephthalate) and glass), are typically less than 0.2 millimeters in thickness. In various embodiments of the present invention, the polymer sheet layer is between 0.2 to 3.0 millimeters, 0.2 to 1.0 millimeters, 0.25 to 0.5 millimeters, or 0.3 to 0.4 millimeters in thickness.

One or more polymer sheets disposed in contact with one another form, as used herein, a “polymer sheet layer.” That is, a polymer sheet layer can comprise 1 or more polymer sheets laminated together to form a single polymer sheet layer. Such constructs are useful, for example, if two thinner polymer sheets having different characteristics are laminated together to form a polymer sheet layer for use between a pane of glass and a polymer film layer.

The polymer sheets of the present invention can comprise any suitable polymer, and, in a preferred embodiment, as exemplified above, the polymer sheet comprises poly(vinyl butyral). In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives, including plasticizers, disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In another embodiment, the polymer sheet comprises a polymer selected from the group consisting of poly(vinyl butyral), polyurethane, polyvinyl chloride, poly(ethylene vinyl acetate), combinations thereof, and the like. In other embodiments, the polymer sheet comprises plasticized poly(vinyl butyral). In further embodiments the polymer sheet comprises poly(vinyl butyral) and one or more other polymers. Other polymers having a suitable glass transition temperature can also be used. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer sheets.

For embodiments comprising poly(vinyl butyral), the poly(vinyl butyral) can be produced by known acetalization processes that involve reacting poly(vinyl alcohol) (PVOH) with butyraldehyde in the presence of an acid catalyst, followed by neutralization of the catalyst, separation, stabilization, and drying of the resin.

In various embodiments, the polymer sheet comprising poly(vinyl butyral) comprises 10 to 35 weight percent (wt. %) hydroxyl groups calculated as PVOH, 13 to 30 wt. % hydroxyl groups calculated as PVOH, or 15 to 22 wt. % hydroxyl groups calculated as PVOH. The polymer sheet can also comprise less than 15 wt. % residual ester groups, 13 wt. %, 11 wt. %, 9 wt. %, 7 wt. %, 5 wt. %, or less than 3 wt. % residual ester groups calculated as polyvinyl acetate, with the balance being an acetal, preferably butyraldehyde acetal, but optionally including other acetal groups in a minor amount, e.g., a 2-ethyl hexanal group (see, for example, U.S. Pat. No. 5,137,954).

In various embodiments, the polymer sheet comprises poly(vinyl butyral) having a molecular weight at least 30,000, 40,000, 50,000, 55,000, 60,000, 65,000, 70,000, 120,000, 250,000, or at least 350,000 grams per mole (g/mole or Daltons). Small quantities of a dialdehyde or trialdehyde can also be added during the acetalization step to increase molecular weight to at least 350 g/m (see, for example, U.S. Pat. Nos. 4,902,464; 4,874,814; 4,814,529; 4,654,179) As used herein, the term “molecular weight” means the weight average molecular weight.

Various adhesion control agents can be used in polymer sheets of the present invention, including sodium acetate, potassium acetate, and magnesium salts. Magnesium salts that can be used with these embodiments of the present invention include, but are not limited to, those disclosed in U.S. Pat. No. 5,728,472, such as magnesium salicylate, magnesium nicotinate, magnesium di-(2-aminobenzoate), magnesium di-(3-hydroxy-2-napthoate), and magnesium bis(2-ethyl butyrate)(chemical abstracts number 79992-76-0). In various embodiments of the present invention the magnesium salt is magnesium bis(2-ethyl butyrate).

Additives may be incorporated into the polymer sheet to enhance its performance in a final product. Such additives include, but are not limited to, the following agents: antiblocking agents, plasticizers, dyes, pigments, stabilizers (e.g., ultraviolet stabilizers), antioxidants, flame retardants, UV absorbers, IR absorbers, and combinations of the foregoing additives, and the like, as are known in the art.

In various embodiments of polymer sheets of the present invention, the polymer sheets can comprise 20 to 60, 25 to 60, 20 to 80, or 10 to 70 parts plasticizer per one hundred parts of resin (phr). Of course other quantities can be used as is appropriate for the particular application. In some embodiments, the plasticizer has a hydrocarbon segment of fewer than 20, fewer than 15, fewer than 12, or fewer than 10 carbon atoms.

The amount of plasticizer can be adjusted to affect the glass transition temperature (T_{g}) of the poly(vinyl butyral) sheet. In general, higher amounts of plasticizer are added to decrease the T_{g}. Poly(vinyl butyral) polymer sheets of the present invention can have a T_{g} of 40° C. or less, 35° C. or less, 30° C. or less, 25° C. or less, 20° C. or less, and 15° C. or less.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779. and C₆ to C₈ adipate esters, such as hexyl adipate. In various embodiments, the plasticizer used is dihexyl adipate and/or triethylene glycol di-2 ethylhexanoate.

As used herein, “resin” refers to the polymeric (for example poly(vinyl butyral)) component that is removed from the mixture that results from the acid catalysis and subsequent neutralization of the polymeric precursors. Resin will generally have other components in addition to the polymer, for example poly(vinyl butyral), such as acetates, salts, and alcohols. As used herein, “melt” refers to a melted mixture of resin with a plasticizer and optionally other additives.

Any suitable method can be used to produce the polymer sheets of the present invention. Details of suitable processes for making poly(vinyl butyral) are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3^{rd} edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

The poly(vinyl butyral) polymer and plasticizer additives can, for example, be thermally processed and configured into sheet form according to methods known to those of ordinary skill in the art. One exemplary method of forming a poly(vinyl butyral) sheet comprises extruding molten poly(vinyl butyral) comprising resin, plasticizer, and additives (hereinafter “melt”) by forcing the melt through a sheet die (for example, a die having an opening that is substantially greater in one dimension than in a perpendicular dimension). Another exemplary method of forming a poly(vinyl butyral) sheet comprises casting a melt from a die onto a roller, solidifying the resin, and subsequently removing the solidified resin as a sheet.

Methods of Forming Multiple Polymer Layers on Glass

The windows of the present invention can be manufactured by any method known in the art. In various embodiments, a single pane of glass and a multiple polymer layer are formed by stacking and then laminating the following layers: glass//polymer sheet//polymer film//glass. Lamination of this stack can be performed by any appropriate laminating process in the art, including known autoclave procedures. After lamination, the pane of glass that is in contact with the polymer film can be peeled off of the polymer film, leaving a single pane of glass having a polymer sheet disposed thereon and a polymer film disposed on the polymer sheet.

The present invention also includes methods of manufacturing a pane of glass having disposed thereon any of the multiple polymer layers of the present invention comprising using a vacuum non-autoclave process. In various embodiments of the present invention, a pane of glass having disposed thereon any of the multiple polymer layers of the present invention is manufactured using a vacuum deairing non-autoclave process embodiment described in U.S. Pat. No. 5,536,347. In various other embodiments, a nip roll non-autoclave process embodiment described in published U.S. application US 2003/0148114 A1 is used.

According to the present invention, a further process—a “double bilayer” process—is described whereby a layered stack having two complete glass and polymer constructs is formed and then laminated in any suitable manner to produce a laminated stack having two complete glass/multiple polymer layer constructs that can be separated at a polymer film//polymer film interface to produce two single glass panes each having disposed thereon a multiple polymer layer. This method is an improvement over methods in which a sacrificial pane of glass is used during lamination of a single glass pane with a multiple polymer layer disposed thereon, because the need for a sacrificial glass layer is eliminated, and two complete panels can be produced with each lamination.

In various embodiments, two constructs are formed into a stack for laminating, wherein each of the two constructs has a glass layer on one side, a polymer film on the other side, and one or more further layers disposed between the glass layer and polymer film layer. The stack is formed with the two outer polymer film layers disposed in contact with one another. This stack layout can be described according to the following: glass//(one or more further layers)//polymer film//polymer film//(one or more further layers)//glass. After lamination, the two constructs can be easily separated at the polymer film//polymer film interface, thereby producing two laminated panels.

In these embodiments, the two panels produced according to the just-described method can be the same or different, as can any individual layer. For example, polymer films can all be the same, or can have different properties. The one or more further layers can be any combination of polymer sheet, polymer film, or glazing layers. Examples of the one or more further layers include, but are not limited to: polymer sheet; polymer sheet//polymer film//polymer sheet; polymer sheet//glass//polymer sheet, and variations thereon.

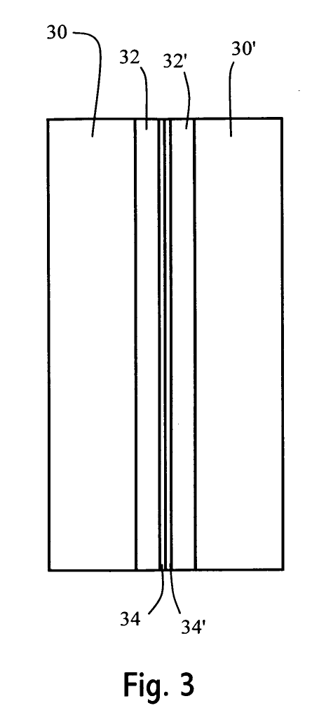

As shown in FIG. 3, various embodiments of this double bilayer method comprise forming a stack of layers as shown, having the following configuration: glass (30)//polymer sheet (32)//polymer film (34)//polymer film (34′)//polymer sheet (32′)//glass (30′). After lamination, the two multiple layer constructs can be easily separated at the interface between the two polymer film layers 34, 34′, which results in two separate glass panes such as the schematic shown in FIG. 2 having a polymer sheet disposed on one side of a pane of glass and a polymer film disposed on the polymer sheet. In these embodiments, the corresponding layers (i.e. the two polymer sheets 32, 32′) can be the same or different.

In yet other embodiments, one or more layers of release film are incorporated into the construct shown in FIG. 3 between the polymer film layers 34, 34′ prior to lamination. After lamination, the two bilayers can be separated at the junction between the release film and a polymer film layer (34 or 34′) in embodiments in which a single release film is used, or the two bilayers can be separated at the junction between two release films in embodiments in which more than one release film is used. One or two of the resulting bilayers will have disposed on the surface of the polymer film layer (34 or 34′) a release film. As is known in the art, release films are useful to protect the underlying layer or layers from mechanical damage, such as scratching, and/or other damage. After installation of the bilayer, the release film is formulated such that removal of the release film is straightforward and can be completed without disturbing the underlying layers.

In various embodiments of the double bilayer method, a nip roll, non autoclave process such at those disclosed in US 2003/0148114 A1 or a vacuum bag, non autoclave process such as that disclosed in U.S. Pat. No. 5,536,347 is used to laminate the various layers. For example, a prelaminate having the layout: glass//(one or more further layers)//polymer film can be formed. A second prelaminate having the same layout can then be formed and added to the first prelaminate stack with the polymer films in contact with each other to form a double bilayer stack. Alternatively, a single stack can be formed all at once with all of the desired layers needed to produce two panels after lamination and separation. In either case, the entire stack can then be laminated using either a nip roll non autoclave process, a vacuum bag non autoclave process, or a conventional autoclave process. In a nip roll process, for example, in various embodiments, the water content of the polymer sheet(s) is kept to less than 0.35% by weight, and more preferably less than about 0.30% or from 0.01% to 0.2%, prior to final lamination, which can then be carried out with high heat and at atmospheric pressure. Alternatively, the moisture content of the polymer sheet(s) can be greater than 0.2% by weight, or from 0.4% to 0.6% by weight, and final lamination can occur at high temperature with the steady reduction of vacuum and without the need for autoclaving.

The present invention includes any of the glass panels having disposed thereon multiple polymer layers that are produced according to the double bilayer process of the present invention, as well as windows and glass panels produced from those glass panels, and, specifically, insulated glass units having multiple polymer layers of the present invention on at least one inside surface.

After manufacture of any of the panes of glass with multiple polymer layers described above, conventional means can be used to incorporate one or more of the constructs into a window. Of course, in addition to use in multiple pane windows, the glass panels having multiple polymer layers that are produced by the double bilayer method can be used in applications other than multiple pane window applications in which such constructs are useful, for example in single pane windows for which extra safety is desired.

In addition to the embodiments given above, other embodiments comprise a rigid substrate other than glass. In these embodiments, which can have the same multiple polymer layers given above, the rigid substrate can comprise acrylic, Plexiglass®, Lexan®, and other plastics that are conventionally used as glazings.

The present invention also includes multiple pane windows having any of the multiple polymer layer constructs described herein as part of the present invention.

The present invention also includes plasma display panels having any of the glass//multiple polymer layer constructs described herein.

The present invention also includes methods of manufacturing multiple pane windows, comprising forming any of the glass//multiple polymer layer constructs of the present invention and then disposing those constructs in a frame to form a multiple pane window.

Measurement Techniques

Various polymer sheet and/or laminated glass characteristics and measuring techniques will now be described for use with the present invention.

The clarity of a polymer sheet, and particularly a poly(vinyl butyral) sheet, can be determined by measuring the haze value, which is a quantification of light not transmitted through the sheet. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)-Procedure A, using Illuminant C, at an observer angle of 2 degrees. In various embodiments of the present invention, percent haze is less than 5%, less than 3%, and less than 1%.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17° C. (0° F.) and manually pummeled with a hammer to break the glass. All broken glass that is not adhered to the poly(vinyl butyral) sheet is then removed, and the amount of glass left adhered to the poly(vinyl butyral) sheet is visually compared with a set of standards. The standards correspond to a scale in which varying degrees of glass remain adhered to the poly(vinyl butyral) sheet. In particular, at a pummel standard of zero, no glass is left adhered to the poly(vinyl butyral) sheet. At a pummel standard of 10, 100% of the glass remains adhered to the poly(vinyl butyral) sheet. For laminated glass panels of the present invention, various embodiments have a pummel of at least 3, at least 5, at least 8, at least 9, or 10. Other embodiments have a pummel between 8 and 10, inclusive.

The “yellowness index” of a polymer sheet can be measured according to the following: Transparent molded disks of polymer sheet 1 cm thick, having smooth polymeric surfaces which are essentially plane and parallel, are formed. The index is measured according to ASTM method D 1925, “Standard Test Method for Yellowness Index of Plastics” from spectrophotometric light transmittance in the visible spectrum. Values are corrected to 1 cm thickness using measured specimen thickness.

The “impact strength” of any of the laminated multiple layer constructs of the present invention can be determined according to the following technique:

a 305 mm×305 mm (12 in×12 in) laminated panel (the “test specimen”) is kept at a temperature of 21° C. to 29° C. (70° F. to 85° F.) for at least 4 hours immediately preceding the test to ensure a uniform testing temperature. The test specimen is supported in a steel frame made in accordance with ANSI Z26.1.

The frame with the specimen is positioned in a substantially horizontal position. A 224 to 230 g (0.5 pounds +/−0.1 ounce) smooth, steel sphere is dropped from a stationary starting position and allowed to free fall a predetermined height, at which point the sphere strikes the specimen within 25 mm (1 inch) of the center of the specimen. The specimen is positioned so that the steel sphere will strike the face of the specimen representing the face mounted to the outside of the window unit. Tests in which a specimen fractures sufficiently to allow the sphere to pass through are recorded as a failure. Tests in which the specimen remains intact, or prevents the sphere from passing through, is recorded as a pass.

The “impact strength” of the specimen is equivalent to the maximum starting height at which the specimen will prevent the sphere from passing through.

### EXAMPLE 1

Six panels are tested for impact strength. The table, below, indicates the composition of each panel and the result of an impact strength test. Polymer sheets are poly(vinyl butyral) sheets having a residual poly(vinyl alcohol) content of about 18.7% and about 39 phr of triethylene glycol bis-(2-ethyl)hexanoate. Polymer films are formed from poly(ethylene terephthalate). Layer thickness are given in parentheses.

| Specimen Construction | Drop Height | Result |
|---|---|---|
| Glass (3.175 mm (0.125″)) | 3.07 meters | Fail |
| | (10.08′) | |
| Glass (3.175 mm (0.125″)) | 3.06 meters | Fail |
| | (10.03′) | |
| Glass//polymer sheet//polymer film | 3.07 meters | Pass |
| (2.29 mm (0.090″)/0.762 mm | (10.06′) | |
| (0.030″)/0.178 mm (0.007″)) | | |
| Glass//polymer sheet//polymer film | 4.59 meters | Pass |
| (2.29 mm (0.090″)/0.762 mm | (15.06′) | |
| (0.030″)/0.178 millimeters (0.007″)) | | |
| Glass//polymer sheet//polymer film | 6.09 meters | Pass |
| (2.29 mm (0.090″)/0.762 mm | (19.99′) | |
| (0.030″)/0.178 mm (0.007″)) | | |
| Glass//polymer sheet//polymer film | 6.10 meters | Pass |
| (2.29 mm (0.090″)/0.762 mm | (20.02′) | |
| (0.030″)/0.178 mm (0.007″)) | | |

As is shown in the table, the glass//polymer sheet//polymer film construct tested has an impact strength of at least 6 meters.

By virtue of the present invention, it is now possible to provide multiple pane windows, and specifically two pane insulated glass units, that have excellent impact resistance, thermal properties, and optical properties.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeable with any ranges, values, or characteristics given for any of the other components of the invention, where compatible, to form an embodiment having defined values for each of the components, as given herein throughout. For example, a polymer sheet can be formed comprising poly(vinyl butyral) having any of the listed residual poly(vinyl alcohol) in any of the ranges given in addition to any of the ranges given for plasticizer, to form many permutations that are within the scope of the present invention.

Figures are understood to not be drawn to scale unless indicated otherwise.

Each reference, including journal articles, patents, applications, and books, referred to herein is hereby incorporated by reference in its entirety.

We claim:

1. A multiple pane window, comprising:
a first pane of glass having an inside surface;
a second pane of glass having an inside surface, wherein said second pane of glass is disposed relative to said first pane of glass so as to form a space between said first pane of glass and said second pane of glass;
a polymer sheet layer disposed in contact with said inside surface of said first pane of glass, wherein said polymer sheet layer has a thickness of 0.2 to 3.0 millimeters and comprises at least one polymer sheet; and,
a polymer film disposed in contact with said polymer sheet layer.

2. The window of claim 1, wherein said polymer sheet comprises plasticized poly(vinyl butyral).

3. The window of claim 2, wherein said polymer sheet further comprises an agent selected from the group consisting of anti-blocking agents, plasticizers, dyes, pigments, stabilizers, antioxidants, flame retardants, UV absorbers, IR absorbers, and combinations of the foregoing.

4. The window of claim 1, wherein said polymer film comprises poly(ethylene terephthalate).

5. The window of claim 4, wherein said polymer film comprises an infrared reflecting layer.

6. The window of claim 1, wherein said polymer sheet has a thickness of 0.25 to 1.0 millimeters.

7. The window of claim 1, wherein said polymer sheet has a thickness of 0.25 to 0.5 millimeters.

8. The window of claim 1, wherein said first pane of glass and said second pane of glass are disposed in a two pane insulated glass unit.

9. The window of claim 1, further comprising a polymer sheet disposed in contact with said inside surface of said second pane of glass.

10. The window of claim 9, further comprising a polymer film disposed in contact with said polymer sheet disposed in contact with said inside surface of said second pane of glass.

11. The window of claim 1, wherein said first pane of glass is tempered glass, heat treated glass, or solar glass.

12. The window of claim 11, wherein said second pane of glass is tempered glass, heat treated glass, or solar glass.

13. A multiple pane window, comprising:
a first pane of glass having an inside surface;
a second pane of glass having an inside surface, wherein said second pane of glass is disposed relative to said first pane of glass so as to form a space between said first pane of glass and said second pane of glass;
a polymer sheet layer disposed in contact with said inside surface of said first pane of glass, wherein said polymer sheet layer comprises at least one polymer sheet; and,
a polymer film disposed in contact with said polymer sheet, wherein the impact strength of said first pane of glass with said polymer sheet layer and said polymer film is at least three meters.

14. The window of claim 13, wherein said impact strength is at least five meters.

15. The window of claim 13, wherein said impact strength is at least seven meters.

16. The window of claim 13, wherein said polymer sheet comprises plasticized poly(vinyl butyral).

17. The window of claim 16, wherein said polymer sheet further comprises an agent selected from the group consisting of anti-blocking agents, plasticizers, dyes, pigments, stabilizers, antioxidants, flame retardants, UV absorbers, IR absorbers, and combinations of the foregoing.

18. The window of claim 13, wherein said polymer film comprises poly(ethylene terephthalate).

19. The window of claim 18, wherein said polymer film comprises an infrared reflecting layer.

20. The window of claim 13, wherein said first pane of glass and said second pane of glass are disposed in a two pane insulated glass unit.

21. The window of claim 13, further comprising a polymer sheet layer disposed in contact with said inside surface of said second pane of glass.

22. The window of claim 21, further comprising a polymer film disposed in contact with said polymer sheet layer disposed in contact with said inside surface of said second pane of glass.

23. The window of claim 13, wherein said first pane of glass is tempered glass, heat treated glass, or solar glass.

24. The window of claim 23, wherein said second pane of glass is tempered glass, heat treated glass, or solar glass.
